(19) United States
(12) Patent Application Publication
(10) Pub. No.: US 2025/0033476 A1
(43) Pub. Date: Jan. 30, 2025

(54) AUTOMOTIVE USER INTERFACE

(71) Applicant: STRATTEC SECURITY CORPORATION, Milwaukee, WI (US)

(72) Inventors: Adam Pirkey, South Milwaukee, WI (US); Stephanie Patricia Lynn, Hoffman Estates, IL (US); Kevin Morris, Waukesha, WI (US); Zachary Husz, West Allis, WI (US); Jose Israel Moreno Garcia Mendoza, Menomonee Falls, WI (US); Abdel H. Salah, Greenfield, WI (US)

(21) Appl. No.: 18/704,647

(22) PCT Filed: Oct. 25, 2022
(86) PCT No.: PCT/US2022/047698

§ 371 Date: Sep. 23, 2024

Related U.S. Application Data
(60) Provisional application No. 63/271,941, filed on Oct. 26, 2021.

(51) Int. Cl. B60K 35/25; B60K 35/10; B60K 35/22; G06F 3/01; G06F 3/044

(52) U.S. Cl. CPC B60K 35/25; B60K 35/10; B60K 35/22; G06F 3/016; G06F 3/044; B60K 2360/332; B60K 2360/34; B60K 2360/782; G06F 2203/04105

(57) ABSTRACT

A user interface for a vehicle includes a base display, a vibrotactile haptic actuator coupled to the base display, and a force sensor coupled to the base display. The user interface also includes an outer layer coupled to the base display. The outer layer is configured to generate surface friction haptic feedback.

### CROSS REFERENCE TO RELATED APPLICATION

This application claims priority to U.S. Provisional Patent Application No. 63/271,941, filed on Oct. 26, 2021, the entire contents of which are incorporated herein by reference.

### FIELD OF THE INVENTION

This disclosure relates to automotive user interfaces, such as user interfaces for steering wheels in trucks, cars, vans, electric vehicles, and other vehicles.

### SUMMARY

In one aspect, the disclosure provides a user interface for a vehicle, the user interface having a base display, a vibrotactile haptic actuator coupled to the base display, and a force sensor coupled to the base display. The user interface also includes an outer layer coupled to the base display. The outer layer is configured to generate surface friction haptic feedback.

In another aspect, the disclosure provides a user interface for a vehicle, the user interface having a capacitive touch sensing surface with a light-emitting diode (LED) backlighting, a vibrotactile haptic actuator coupled to the capacitive touch sensing surface, and a force sensor coupled to the capacitive touch sensing surface.

In another aspect, the disclosure provides a user interface for a vehicle, the user interface having a liquid crystal display (LCD), and an outer layer coupled to the LCD, the outer layer having surface friction haptic feedback and capacitive touch sensing.

In another aspect, the disclosure provides a user interface for a vehicle, the user interface having a capacitive touch sensing surface with surface friction haptic feedback and with light-emitting diode (LED) backlighting,

In another aspect, the disclosure provides a user interface for a vehicle, the user interface having a liquid crystal display (LCD) capacitive touch sensing display, a vibrotactile haptic actuator coupled to the LCD capacitive touch sensing display, and a force sensor coupled to the LCD capacitive touch sensing display.

In another aspect, the disclosure provides a vehicle system having a steering wheel and a user interface pivotally coupled to the steering wheel.

In another aspect, the disclosure provides a steering wheel user interface having a liquid crystal display (LCD) capacitive sensing display with surface haptic frictional feedback.

In another aspect, the disclosure provides a steering wheel user interface having a capacitive sensing surface with backlight light-emitting diodes (LEDs) and surface frictional haptic feedback.

In another aspect, the disclosure provides a steering wheel user interface having a liquid crystal display (LCD) capacitive sensing display with force sensing and vibrotactile haptic feedback based on a sensed force.

In another aspect, the disclosure provides a steering wheel user interface device having a capacitive touch sensing surface with backlight light-emitting diodes (LEDs), force sensing, and vibrotactile feedback based on a sensed force.

Other embodiments and aspects of various embodiments will become apparent by consideration of the detailed description and accompanying drawings.

### BRIEF DESCRIPTION OF THE DRAWINGS

FIG. 1 is a perspective view of a steering wheel having a user interface.

FIG. 2 is a perspective view of the user interface.

FIG. 3 is an exploded view of the user interface.

FIGS. 4 and 5 are views of alternative versions of the user interface.

FIGS. 6-8 are schematic views of various surface friction haptic feedback zones and divider walls for the user interface.

FIG. 9 is a perspective view of the user interface, illustrating examples of locations for vibrotactile haptic actuators and force sensors.

FIGS. 10 and 11 illustrate a menu and volume control for the user interface.

FIGS. 12 and 13 illustrate a structure that may be touched to turn on and off various icons on the user interface.

FIGS. 14 and 15 are exploded views of alternate versions of the user interface.

FIGS. 16 and 17 are perspective views of a pivot feature of the user interface that permits deployment of an air bag.

### DETAILED DESCRIPTION

Before any embodiments are explained in detail, it is to be understood that embodiments are not limited in their application to the details of construction and the arrangement of components set forth in the following description or illustrated in the following drawings. Other embodiments are possible, and embodiments described and illustrated are capable of being practiced or of being carried out in various ways.

The present disclosure is related to technologies and combinations of technologies for use on a steering wheel, and in particular for use on a user interface of a steering wheel. As described herein, such technologies may include, but are not limited to, (1) vibrotactile sensor(s)/actuator(s) for force detection on a user interface; (2) force sensor(s)/transducer(s) for force detection on the user interface; (3) vibrotactile sensor(s)/actuator(s) for haptic feedback; (4) capacitive touch sense display(s); (5) capacitive sense surface(s) with backlighting; and/or (6) surface frictional haptic feedback.

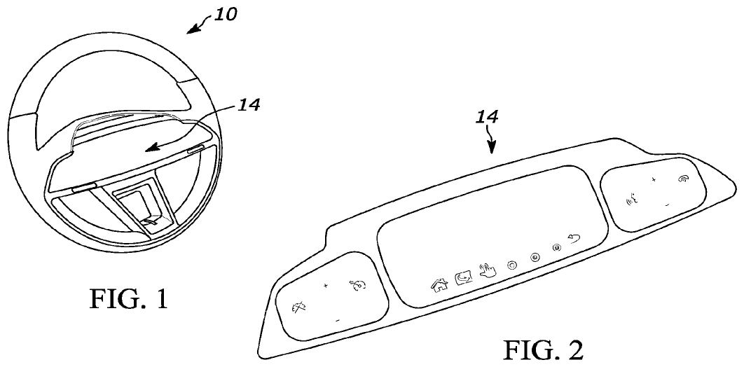

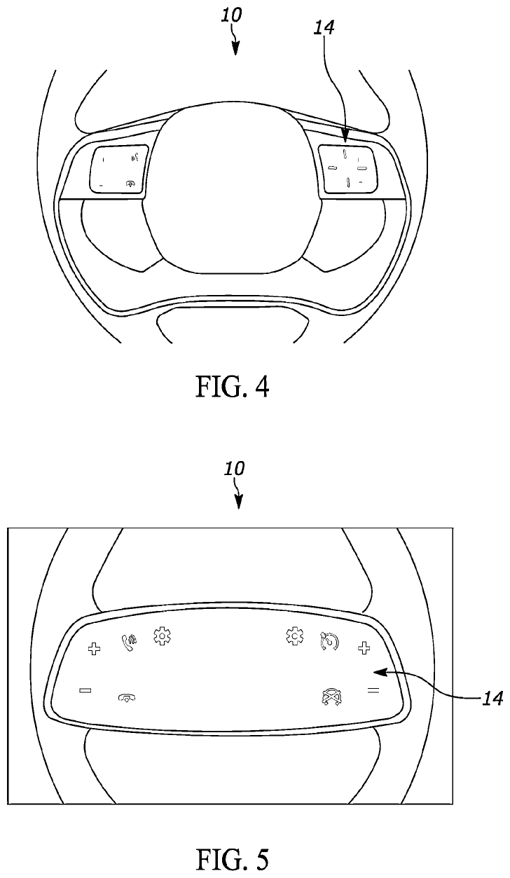

FIGS. 1-17 illustrate a steering wheel 10. The steering wheel 10 may be used, for example, on a motor vehicle (truck, sedan, van, etc.), or other vehicles or equipment. As illustrated in FIGS. 1-17, the steering wheel 10 includes a user interface 14. The user interface 14 is positioned generally centrally (e.g., along a steering wheel hub), although other embodiments may include different positions for the user interface 14 (e.g., located at a top of the steering wheel 10, along a bottom of the steering wheel 10, along a side of the steering wheel 10, along an outer ring of the steering wheel 10, etc.). In some embodiments, the user interface 14 may be used on other vehicle components other than a steering wheel 10 (e.g., on a center console). Overall, the user interface 14 may allow a driver or other user to operate and/or adjust (e.g., by touching and/or swiping one or more icons or other symbols or buttons on the user interface 14) various features in the vehicle, including but not limited to cruise control and speed, phone calls, haptic levels, heating, air conditioning, radio stations, radio volume, navigation, vehicle lighting, etc.

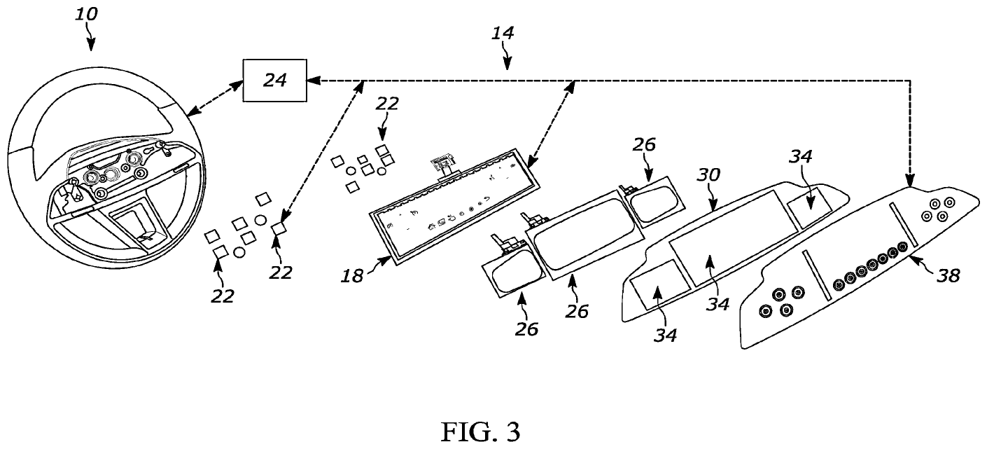

With reference to FIG. 3, the user interface 14 may include at least one display 18 (e.g., base display). In the illustrated embodiment, the display 18 is a liquid crystal display (LCD), although other embodiments may include different types of displays 18 (e.g., thin film transistor (TFT), or organic light-emitting diode (OLED)). As illustrated in FIG. 3, the display 18 may form a base, or lower layer, of the user interface 14, although in other embodiments the display 18 may form a middle layer, or upper layer, of the user interface 14. In some embodiments, the display 18 is or forms part of an LCD capacitive sensing display 18.

With continued reference to FIG. 3, the user interface 14 may include at least one sensor 22. In some embodiments, at least one of the sensors 22 is a combined, single vibrotactile haptic actuator and force sensor. In some embodiments, at least one of the sensors 22 is a discrete vibrotactile haptic actuator (e.g., linear resonant actuator (LRA), eccentric rotating mass (ERM), or magnetic voice coil). In some embodiments, at least one of the sensors 22 is a discrete force sensor (e.g., Strain gauge) for force detection on the user interface 14. The sensors 22 may include a combination of discrete vibrotactile haptic actuators, discrete force sensors, and/or combined vibrotactile haptic actuators and force sensors.

In the illustrated embodiment, the user interface 14 includes a plurality of combined, single vibrotactile haptic actuators/force sensors 22, each coupled to the display 18. Each of the combined, single vibrotactile haptic actuators/force sensors 22 includes, for example, piezoelectric elements capable of force detection and haptic feedback. Other embodiments may include different numbers and arrangements of piezoelectric elements, or may include combined, single vibrotactile haptic actuators and force sensors 22 having elements other than piezoelectric elements.

The sensors 22 described above may sense a force applied to the user interface 14 (e.g., sensed force from a finger or fingers pressing down). As illustrated in FIG. 3, each of the sensors 22 may be driven by a microcontroller (e.g., microprocessor) 24 to vibrate in response to the force applied, to confirm that a user has pressed a finger against the user interface 14. The microcontroller 24 may be located for example on a printed circuit board on or within the steering wheel 10. In some embodiments, vibrational feedback may be activated as the user presses on the user interface 14 and as the user removes the force in two discrete feedback responses. The sensors 22 may also vibrate differently to indicate to the user how close a finger is to an icon on the user interface 14 with the finger location sensed, for example, by a capacitive touch sense surface 26. For example, stronger vibrations may be felt when the finger is far from the icon, and gradually weaker vibrations as the finger is moved closer, or weaker vibrations when the finger is far from the icon, and gradually stronger vibrations as the finger is moved closer.

With continued reference to FIG. 3, and as described above, the user interface 14 may include at least one capacitive touch sense surface 26 (e.g., sensing surface with or without backlighting). In the illustrated embodiment, the user interface 14 includes three capacitive touch sense surfaces 26 (one larger central capacitive touch sense surface 26 and two smaller capacitive touch sense surfaces 26), each backlit with light-emitting diodes (LEDs). Other embodiments may include other types of backlighting, or no backlighting. In some embodiments, the capacitive touch sense surfaces 26 are (or form part of) thin film transistor (TFT) or organic light-emitting diode (OLED) touch displays. As illustrated in FIG. 3, one or more of the sensors 22 may be positioned behind the display 18 (e.g., on a backplate behind the display 18). In some embodiments, one or more of the sensors 18 may be positioned in front of the display 18, or to a side of the display 18. For example, in some embodiments, the user display 14 may include at least one vibrotactile haptic actuator sensor 22 that is positioned behind the display 18, and may include at least one force sensor 22 that is positioned in front of, or to a side of, the display 18. The capacitive touch sense surfaces 26 may be positioned over the display 18, or for example be integrally formed as part of the display 18. In some embodiments, some of the sensors 22 are positioned (e.g., sandwiched) between the capacitive touch sense surfaces 26 and a portion of the display 18. Other embodiments may include different numbers and arrangements of the capacitive touch sense surface(s) 26, sensors 22 and display(s) 18 than that illustrated. For example, as described above, in some embodiments the capacitive touch sense surfaces 26 may be formed integrally as part of (e.g., in one piece with) the display 18. In some embodiments the sensors 22 may be formed as part of the capacitive touch sense surfaces 26, or as part of the display 18, or as part of other components on the user interface 14.

With continued reference to FIG. 3, in some embodiments the user interface 14 may include a film 30 (e.g., frame) with cutouts 34 sized and shaped to correspond to the size and shape of the three capacitive touch sense surfaces 26. The film 30 may be placed, for example, over the display 18 and/or the capacitive touch sense surfaces 26. Other embodiments may not include the film 30, or may include a film 30 having other numbers and arrangements of cutouts 34 than that illustrated.

With continued reference to FIG. 3, the user interface 14 may include at least one outer layer 38 with surface friction haptic feedback and/or capacitive touch sensing. For example, in the illustrated embodiment, the outer layer 38 is a single discrete layer (e.g., made at least partially of plastic) that is coupled to, and extends over, each of the three capacitive touch sense surfaces 26 and the film 30. In other embodiments, the outer layer 38 may be coupled instead, for example, to only one of the capacitive touch sense surfaces 26, or to another component. In some embodiments, the outer layer 38 is formed integrally as part of (e.g., in one piece with with) the capacitive touch sense surface(s) 26, and/or the display(s) 18, and/or other components of the user interface 14. For example, in some embodiments the user interface 14 include a single display 18 that includes both capacitive touch sense surfaces 26 thereon and also surface friction haptic feedback thereon (rather than a discrete display 18, a discrete set of capacitive touch sense surfaces 26, and a discrete outer layer 38). At least one of the sensors 22 may be located, for example, behind the single display 18.

The surface friction haptic feedback provided on the outer layer 38 (e.g., on a sensing surface of the outer layer 38) may include “textures” (e.g., software-designed textures), such as fine textures, edges, bumps, detents, etc. The surface friction haptic feedback may generate changes in friction on the outer layer 38 that are perceived as these textures. The textures may be felt without looking. The textures may be felt, for example, by a user as the user's finger touches (e.g., slides or swipes) across the surface of the outer layer 38. With continued reference to FIGS. 1-3, the microcontroller 24 (in combination for example with a driver chip(s)), may generate these textures by varying an electric field or fields on the surface of the outer layer 38 (e.g., using a circuit or circuits). In some embodiments, a different texture may be provided for each icon on the user interface 14 (e.g., a home icon, a volume icon, a phone icon, etc.) displayed on the outer layer 38, to indicate to the user which icon the user's finger is over without having to look at the screen. With reference to FIG. 3, in some embodiments the microcontroller 24 may be coupled to at least one of the display 18, at least one of the sensors 22, and the outer layer 38.

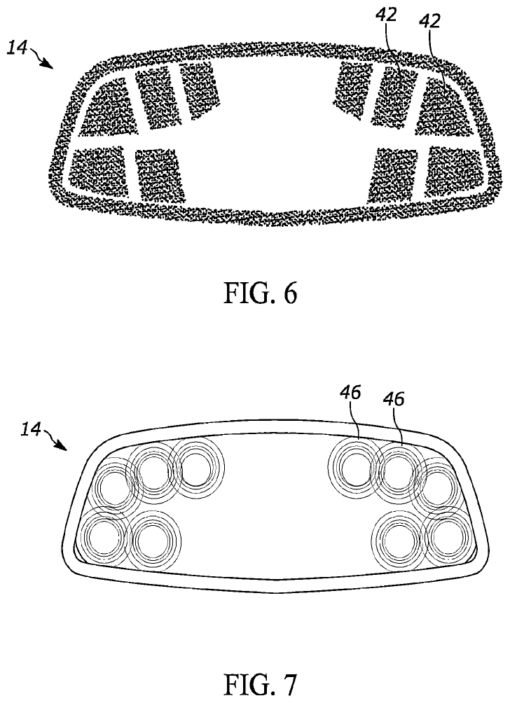

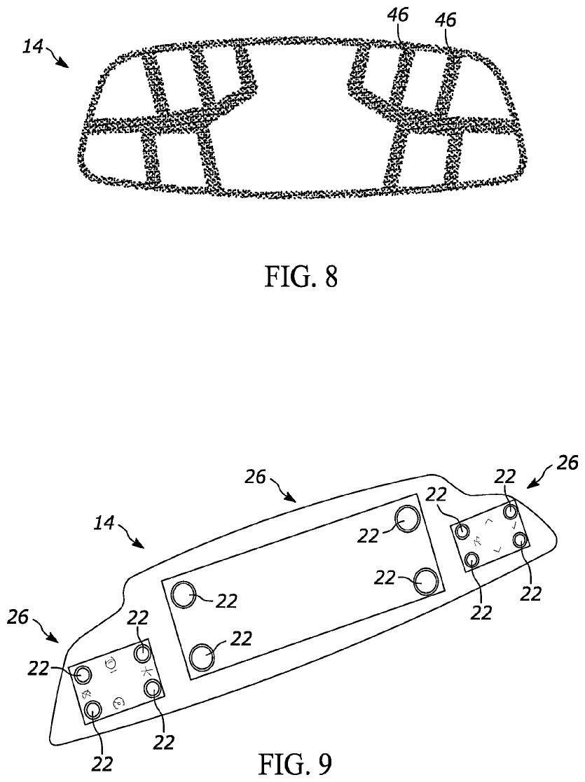

With reference to FIGS. 6-8, the user interface 14 may include mapping, having at least one zone 42 corresponding to a texture created on the outer layer 38 (e.g., by the microcontroller 24 as described above). For example, as illustrated in FIG. 6, the user interface 14 may include a variety of zones 42. Each of the zones 42 may provide the same texture and feel to the user, or for example may provide different textures and feels to the user, depending on the vehicle feature associated with each zone 42. In some embodiments, and with reference to FIGS. 7 and 8, the textures may form a divider wall or walls 46 between each icon on the user interface 14, providing surface friction haptic feedback to indicate to the user that the finger is moving (e.g., sliding) from one icon to another without looking at the user interface 14. With continued reference to FIGS. 6-8, in the illustrated embodiment the darker (e.g., black) areas (e.g., the divider wall or walls 46) may correspond to areas with higher friction, whereas the lighter (e.g., white) areas may correspond to areas with lower, or no, friction or texture. In some embodiments, and as illustrated in FIG. 7, the circular divider walls 46 may provide higher levels of friction than other areas along the user interface 14. Moving inwardly from these walls 46 (e.g., toward an icon on the user interface 14), the friction may be reduced and eventually eliminated.

In some embodiments, the different settings such as the level of surface friction on the user interface 14 (e.g., on the outer layer 38), or the car volume, or the song selected, may be adjusted through a slider or knob on the user interface 14 with detent feeling feedback through the surface friction haptic feedback. In some embodiments, the surface friction haptic feedback described above for the outer layer 38, and/or the force sensing with vibrotactile feedback described above that is associated with the sensors 22, may be used on a surface of a steering wheel user interface 14 that does not have a display screen. Such a user interface 14 may have icons with backlighting, and such icons may be secret or hidden until they are lit.

As described above, the user interface 14 may include one or more sensors 22 (e.g., to provide feedback that a user has pressed or touched the user interface 14). The user interface 14 may include surface friction haptic feedback, through the use of textures created by electric fields. With reference to FIG. 9, in some embodiments the sensors 22 may be positioned and spaced out along the user interface 14 in different patterns or spacings (represented by the round “dots” in FIG. 9). In the illustrated embodiment, each of the three capacitive touch sense surfaces 26 has four sensors 22, spaced in the four corners of the capacitive touch sense surface 26. Other embodiments may include different numbers and arrangements of sensors 22.

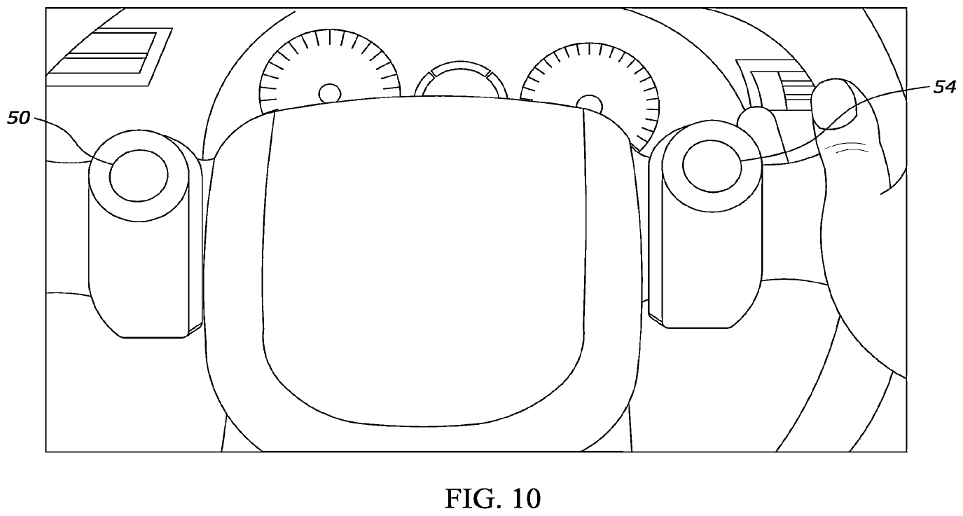

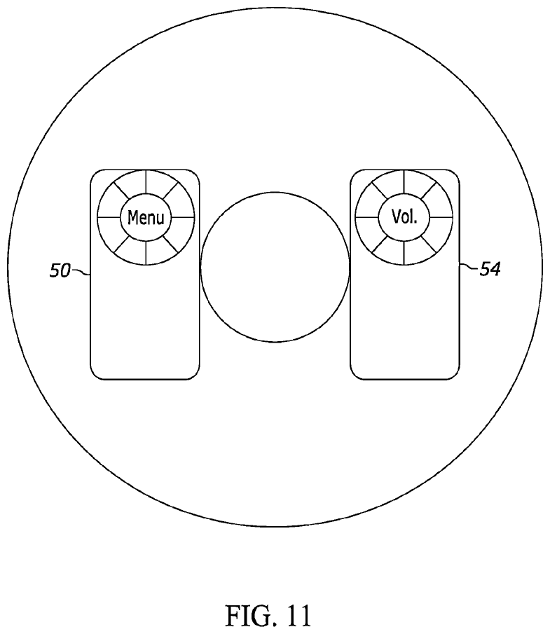

With reference to FIGS. 10 and 11, in some embodiments a surface of the user interface 14 (e.g., the outer layer 38) may incorporate the surface friction haptic feedback and the “textures” described above to provide a detent feel as the user moves a finger in a circle around the surface. For example, this detent may be felt around the surface of a menu 50 and/or a volume 54 user interface region. The friction that is generated may vary from low to high or high to low as the finger is moved around the surface to indicate and confirm actions taken by the user interface (e.g., volume increase or decrease, navigating through a menu of options, etc.).

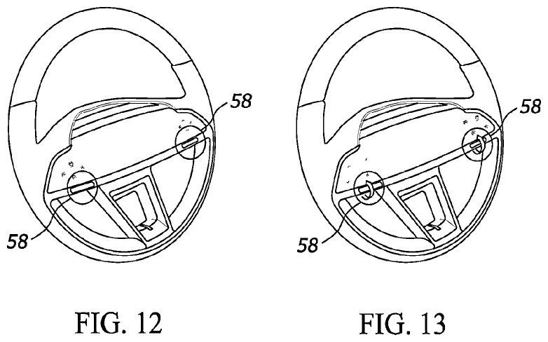

With reference to FIGS. 12 and 13, in some embodiments the user interface 14 may include a physical structure or structures 58 (e.g., chrome roller wheels) along or adjacent the outer layer 38. If these structures 58 are capacitive, they may be used for example to turn on different capacitive backlight options (e.g., icons) and turn others off. For example, if the user touches/moves the structure 58, a first set of icons may appear on the user interface 14, and if the user touches/moves the structure 58 again a different set of icons may appear (with the first set going dark or otherwise becoming hidden).

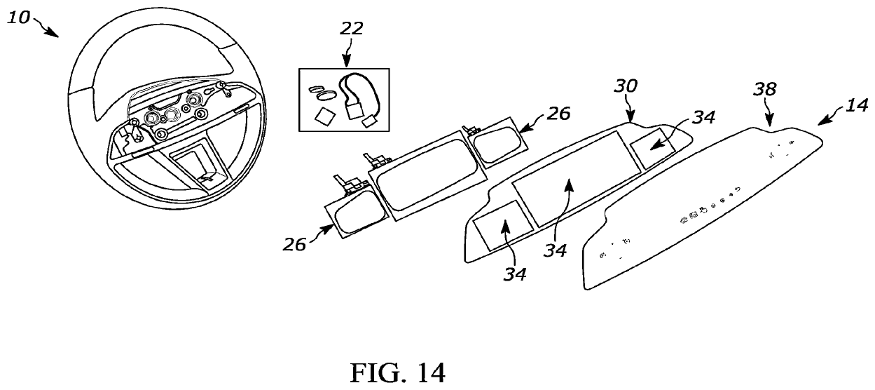

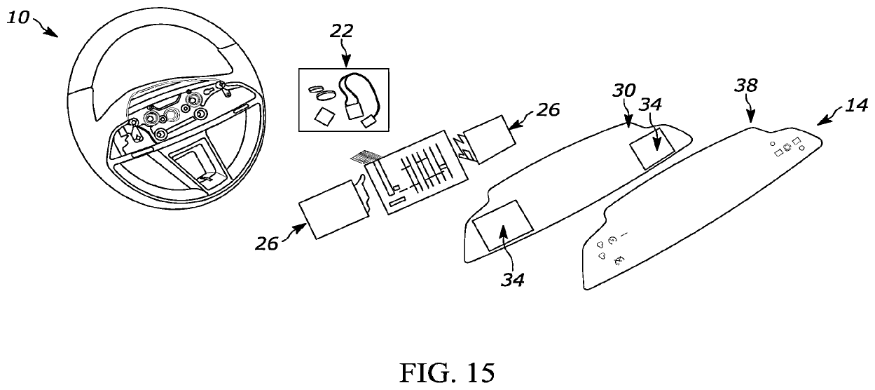

As noted above, the user interface 14 may include any number and combination of the components described herein (e.g., any number and combination of a base display(s) 18, sensor(s) 22 (combined or discrete), capacitive touch sense surface(s) 26, or outer layer(s) 38 with surface frictional haptic feedback). FIGS. 14 and 15 illustrate one comparison, for example, between a user interface 14 that includes three capacitive touch sense surfaces 26 (FIG. 14), as compared to a user interface 14 that includes two capacitive touch sense surfaces 26 (FIG. 15). In each case, the overall user interface 14 may still have the look and feel of a single unitary user interface 14 (e.g., one large touch display module).

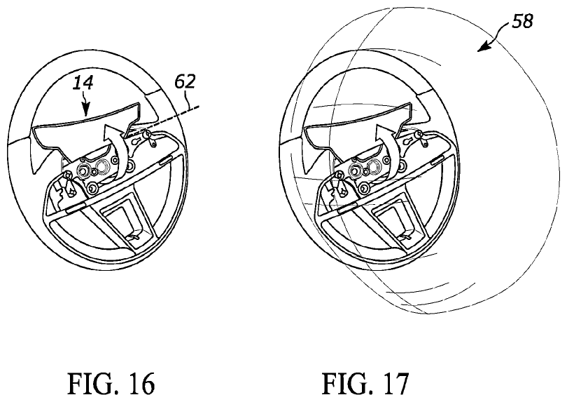

With reference to FIGS. 16 and 17, in some embodiments the user interface 14 (or at least a portion thereof) may be moveable (e.g., pivotable) between a first position and a second position relative to the steering wheel 10, such that an airbag 66 may be deployed. For example, and as illustrated in FIGS. 16 and 17, at least a portion of the user interface 14 (including a printed circuit board) may pivot about an axis 62 (e.g., about a living hinge, pin, or other pivot structure) along a top of the user interface 14. Once pivoted (e.g., pivoted upwardly), this portion of the user interface 14 may still remain within an outer diameter of the steering wheel 10. Other embodiments may include different pivot axes or pivot points.

Although various embodiments have been described in detail with reference to certain examples illustrated in the drawings, variations and modifications exist within the scope and spirit of one or more independent aspects described and illustrated.

We claim:

1. A user interface for a vehicle, the user interface comprising:
a base display;
a vibrotactile haptic actuator coupled to the base display,
a force sensor coupled to the base display, and
an outer layer coupled to the base display, the outer layer configured to generate surface friction haptic feedback.

2. The user interface of claim 1, wherein the base display is a liquid crystal display (LCD).

3. The user interface of claim 1, wherein the base display is a lower layer of a steering wheel user interface.

4. The user interface of claim 1, wherein the vibrotactile haptic actuator and the force sensor are a combined, single sensor.

5. The user interface of claim 1, wherein the vibrotactile haptic actuator is a discrete actuator, and the force sensor is a discrete force sensor.

6. The user interface of claim 1, further comprising a capacitive touch sense surface.

7. The user interface of claim 6, wherein the vibrotactile haptic actuator is positioned behind the base display and the force sensor is positioned behind or in front of the base display, and wherein the outer layer is positioned over the capacitive touch sense surface.

8. The user interface of claim 1, wherein the surface friction haptic feedback on the outer layer includes different textures configured to be felt by a finger of a user as the finger moves over the outer layer.

9. The user interface of claim 1, wherein the different textures include edges and bumps.

10. The user interface of claim 1, further comprising a microcontroller configured to vary an electric field along the outer layer to generate the surface friction haptic feedback.

11. The user interface of claim 10, wherein the varying electric field is configured to create different levels of friction.

12. The user interface of claim 10, wherein the vibrotactile haptic actuator and the force sensor are configured to be driven by the microcontroller to vibrate in response to a force applied to a steering wheel user interface by a user's finger.

13. A user interface for a vehicle, the user interface comprising:
a capacitive touch sense surface;
a vibrotactile haptic actuator coupled to the capacitive touch sense surface; and
a force sensor coupled to the capacitive touch sense surface.

14. The user interface of claim 13, wherein the vibrotactile haptic actuator and the force Sensor are a combined, single sensor.

15. The user interface of claim 13, wherein the vibrotactile haptic actuator is a discrete actuator, and force sensor is a discrete force sensor.

16. The user interface of claim 13, wherein the vibrotactile haptic actuator and the force sensor are each positioned underneath the capacitive touch sense surface.

17. The user interface of claim 13, further comprising an outer layer coupled to the capacitive touch sense surface, the outer layer configured to generate surface friction haptic feedback.

18. A user interface for a vehicle, the user interface comprising:
a liquid crystal display (LCD); and
an outer layer coupled to the LCD, the outer layer having surface friction haptic feedback and capacitive sensing.

19. The user interface of claim 18, further comprising a vibrotactile haptic actuator and a force sensor each coupled to the LCD.

20. The user interface of claim 18, wherein the surface friction haptic feedback on the outer layer includes different textures configured to be felt by a finger of a user as the finger moves over the outer layer.

21. A user interface for a vehicle, the user interface comprising:
a capacitive sensing surface with surface friction haptic feedback and light-emitting diode (LED) backlighting; and
a force sensor coupled to the capacitive sensing surface.

22. The user interface of claim 21, further comprising a vibrotactile haptic actuator coupled to the capacitive sensing surface.

23. The user interface of claim 21, wherein the surface friction haptic feedback includes different textures configured to be felt by a finger of a user.

24. The user interface of claim 21, further comprising a microcontroller configured to vary an electric field to generate the surface friction haptic feedback.

25. A user interface for a vehicle, the user interface comprising:
a liquid crystal display (LCD) capacitive sensing display,
a vibrotactile haptic actuator coupled to the LCD capacitive sensing display; and
a force sensor coupled to the LCD capacitive sensing display.

26. The user interface of claim 25, wherein the vibrotactile haptic actuator and the force sensor are a combined, single sensor.

27. The user interface of claim 25, wherein the vibrotactile haptic actuator is a discrete actuator, and force sensor is a discrete force sensor.

28. A vehicle system comprising:
a steering wheel;
a user interface pivotally coupled to the steering wheel;
wherein the user interface includes a display, a force sensor coupled to the display, and an outer layer having surface friction haptic feedback.

29. The vehicle system of claim 28, wherein the user interface includes a vibrotactile haptic actuator coupled to the display

30. The vehicle system of claim 29, further comprising a capacitive touch sense surface positioned underneath the outer layer.

31. A steering wheel user interface comprising:
a liquid crystal display (LCD) capacitive sensing display with surface haptic frictional feedback.

32. The steering wheel user interface of claim 31, wherein the sensing display further includes vibrotactile feedback based on a sensed force.

33. A steering wheel user interface comprising:
a capacitive sensing surface with
backlight light-emitting diodes (LEDs),
surface haptic frictional feedback.

34. The steering wheel user interface of claim 33, wherein the sensing surface further includes force sensing, and vibrotactile haptic feedback based on a sensed force.

35. A steering wheel user interface device comprising:
a liquid crystal display (LCD) capacitive sensing display with
force sensing and
vibrotactile haptic feedback based on a sensed force.

36. A steering wheel user interface comprising:
a capacitive touch sensing surface with
backlight light-emitting diodes (LEDs),
force sensing, and
vibrotactile feedback based on a sensed force.
